(19) United States
(12) Patent Application Publication
(10) Pub. No.: US 2023/0171124 A1
(43) Pub. Date: Jun. 1, 2023

(54) ELECTRONIC DEVICE AND OPERATION METHOD OF ELECTRONIC DEVICE CONTROLLING EXTERNAL DEVICE

(71) Applicant: SAMSUNG ELECTRONICS CO., LTD., Suwon-si (KR)

(72) Inventors: Sunghyun HONG, Suwon-si (KR); Dowan KIM, Suwon-si (KR); Junsuk KIM, Suwon-si (KR); Hyuncheol PARK, Suwon-si (KR); Hwajeong SON, Suwon-si (KR); Eunmo YANG, Suwon-si (KR); Donghyun LEE, Suwon-si (KR)

(21) Appl. No.: 18/098,980

(22) Filed: Jan. 19, 2023

Related U.S. Application Data
(63) Continuation of application No. PCT/KR2022/019342, filed on Dec. 1, 2022.

(30) Foreign Application Priority Data
Dec. 1, 2021 (KR) 10-2021-0170031
Jan. 27, 2022 (KR) 10-2022-0012042

(51) Int. Cl. H04L 12/28; G05B 15/02

(52) U.S. Cl. CPC H04L 12/282; G05B 15/02; G05B 2219/2642

(57) ABSTRACT

An electronic device may include a communication module communicating with at least one of a first external electronic device and a second external electronic device, wherein the first external electronic device may perform a first operation, a database storing information related to at least one associated device and at least one associated operation for controlling the at least one associated device with a specified command in response to a specified operation of the first external electronic device, wherein the at least one associated device may include the second external electronic device and wherein the at least one associated operation may include a second operation, and at least one processor, wherein the at least one processor may identify that a first operation of the first external electronic device is executed, identify, from the database, a second external electronic device that is an associated device corresponding to the first operation of the first external electronic device and a second operation that is an associated operation in response to identifying that the first external electronic device is located in a specified space and satisfies an associated operation execution condition, and transmit a command for executing the second operation to the second external electronic device through the communication module.

### CROSS-REFERENCE TO RELATED APPLICATIONS

This application is a continuation of International Application No. PCT/KR2022/019342 designating the United States, filed on Dec. 1, 2022, in the Korean Intellectual Property Receiving Office and claiming priority to Korean Patent Application No. 10-2021-0170031 filed on Dec. 1, 2021, in the Korean Intellectual Property Office, and to Korean Patent Application No. 10-2022-0012042 filed on Jan. 27, 2022, in the Korean Intellectual Property Office, the disclosures of all which are incorporated by reference herein in their entireties.

### BACKGROUND

### Field

The disclosure relates to an electronic device configured to control an external device, and a method for operating the electronic device. More particularly, the disclosure relates to an electronic device configured to generate an associated operation based on an operation of an external device and to control execution of the generated associated operation, and a method for operating the electronic device.

### Description of Related Art

Internet of Things (IoT) refers to a group of devices which have functions for transmitting/receiving information through networks and thus are capable of transmitting/receiving information through networks. Recently, IoT has been applied to home appliances such as domestic refrigerators, washing machines, and dish washers such that smart refrigerators, smart washing machines, and smart dish washers have been widely used.

In general, such IoT devices may be controlled in IoT environments, wherein the IoT devices are connected to a server (for example, SmartThings cloud), and users may identify conditions of devices through terminal applications (for example, SmartThings app) and deliver commands to IoT devices through the server.

In particular, IoT devices may be connected to a server (or cloud) in the following manners: connected via a hub through a network (for example, ZigBee, Zwave, LAN) (hub-connected); connected directly through a network (for example, Wi-Fi) (direct-connected); or a device registered in a third-party cloud is connected to a cloud-to-cloud type (cloud-connected).

### SUMMARY

The history of use of IoT devices may be managed by a server. For example, use history such as the position, operating time, and operating detail of IoT devices connected to the server may be stored in the server as data, which may be managed by the server.

An electronic device according to various embodiments disclosed herein may recommend, based on the history of use of IoT devices, an operation of an associated IoT device. For example, when a user executes a first operation of a first IoT device (for example, operates an air cleaner at a first air-cleaning level) and then executes a second operation of a second IoT device (for example, operates an air conditioner at a 25° cooling mode), an electronic device according to various embodiments disclosed herein may identify the same as associated operations. In addition, in response to the first operation of the first IoT device executed by the user (for example, operates an air cleaner at a first air-cleaning level), the electronic device according to various embodiments may control the second IoT device to perform the second operation of the second IoT device (for example, operates an air conditioner at a 25° cooling mode) as an associated operation.

Technical problems to be solved by the disclosure are not limited to the above-mentioned technical problems, and other features and advantages not mentioned herein will be clearly understood from the following description.

An electronic device according to various embodiments disclosed herein may include a communication module configured to communicate with at least one of a first external electronic device and a second external electronic device, wherein the first external electronic device is able to perform a first operation, a database configured to store information related to at least one associated device and at least one associated operation for controlling the at least one associated device with a specified command in response to a specified operation of the first external electronic device, wherein the at least one associated device includes the second external electronic device and wherein the at least one associated operation includes a second operation, and at least one processor, wherein the at least one processor is configured to identify that a first operation of the first external electronic device is executed, identify, from the database, a second external electronic device that is an associated device corresponding to the first operation of the first external electronic device and a second operation that is an associated operation in response to identifying that the first external electronic device is located in a specified space and satisfies an associated operation execution condition, and transmit a command for executing the second operation to the second external electronic device through the communication module.

A method for operating an electronic device according to various embodiments disclosed herein may include identifying that a first operation of a first external electronic device is executed, identifying information stored in a database in response to identifying that the first external electronic device is located in a specified space and satisfies an associated operation execution condition, wherein the database stores information related to at least one associated device and at least one associated operation for controlling the at least one associated device with a specified command in response to a specified operation of the first external electronic device, wherein the at least one associated device includes the second external electronic device and wherein the at least one associated operation includes a second operation, identifying, from the database, a second external electronic device that is an associated device corresponding to a first operation of the first external electronic device and a second operation that is an associated operation, and transmitting a command for executing the second operation to the second external electronic device through a communication module.

An electronic device according to various embodiments may generate associated operations based on a user’s history of use of an external electronic device.

An electronic device according to various embodiments may control, in response to a designated operation of an external electronic device executed by a user, that an associated operation is executed.

An electronic device according to various embodiments may analyze a user’s pattern of use of an external electronic device and provide associated operations, thereby enabling the user to use the external electronic device conveniently.

### BRIEF DESCRIPTION OF THE DRAWINGS

With respect to the description of the drawings, the same or similar reference numerals may be used for the same or similar components.

The above and other aspects, features and advantages of certain embodiments of the present disclosure will be more apparent from the following detailed description, taken in conjunction with the accompanying drawings, in which:

FIG. 1 is a block diagram of an example electronic device in a network environment according to various embodiments;

FIG. 2 is a block diagram of an example electronic device control system according to various embodiments;

FIG. 3 is a diagram illustrating an example of an electronic device control system according to various embodiments;

FIG. 4A is a flowchart illustrating an example method in which a server generates an associated operation based on operations of electronic devices according to various embodiments;

FIG. 4B is a flowchart illustrating an example method in which a server generates an associated operation based on operations of electronic devices in a system according to various embodiments;

FIG. 5A is a flowchart illustrating an example method in which a server executes an associated operation based on operations of electronic devices according to various embodiments;

FIG. 5B is a flowchart illustrating an example method in which a server executes an associated operation based on operations of electronic devices in a system according to various embodiments; and

FIG. 5C is a flowchart illustrating an example method in which a server recommends and executes an associated operation based on operations of electronic devices in a system according to various embodiments;

### DETAILED DESCRIPTION

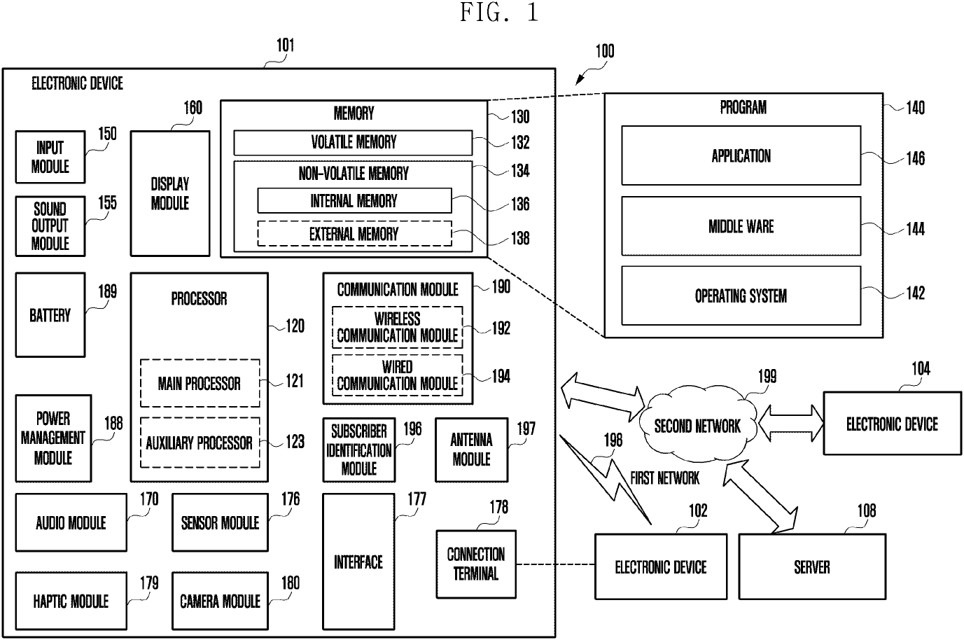

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connection terminal 178, a haptic module 179, a camera module 180, a power management module 188, a battery 189, a communication module 190, a subscriber identification module (SIM) 196, or an antenna module 197. In various embodiments, at least one of the components (e.g., the connection terminal 178) may be omitted from the electronic device 101, or one or more other components may be added in the electronic device 101. In various embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connection terminal 178 may include a connector via which the electronic device 101 may be physically connected with the external electronic device (e.g., the electronic device 102). According to an embodiment, the connection terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of or including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

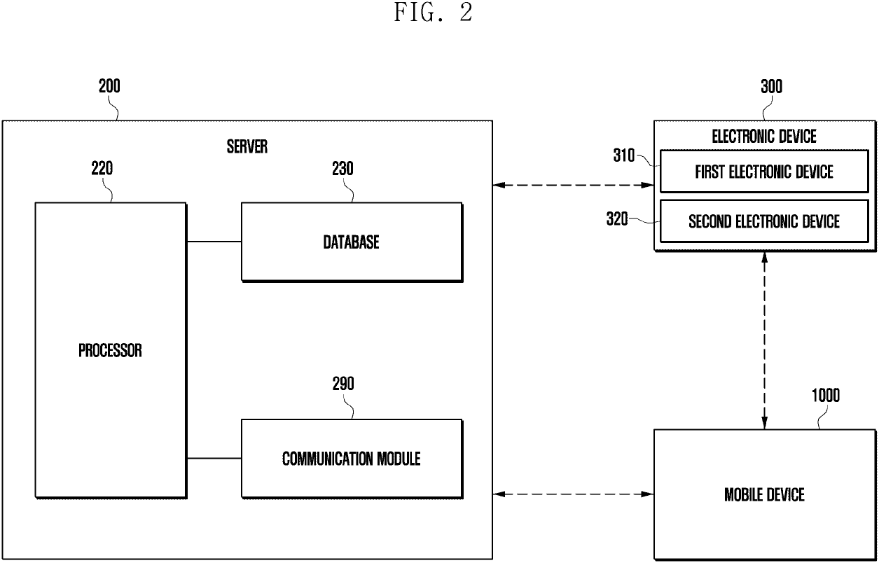

FIG. 2 is a block diagram of an example electronic device control system according to various embodiments.

Referring to FIG. 2, a system may include a server 200, an electronic device 300, and/or a mobile device 1000.

According to various embodiments, the server 200 (e.g., the electronic device 101 of FIG. 1) may include a processor 220 (e.g., the processor 120 of FIG. 1), a database 230 (e.g., the memory 130 of FIG. 1), and/or a communication module 290 (e.g., the communication module 190 of FIG. 1). The components included in FIG. 2 are for some of the components included in the server 200, and the server 200 may also include various components as illustrated in FIG. 1.

According to various embodiments, the database 230 may temporarily or non-temporarily store at least one of information related to the electronic device 300, information related to the operation of the electronic device 300, and information related to an associated operation of the operation of the electronic device 300.

According to an embodiment, the database 230 may store information related to the electronic device 300. For example, the information related to the electronic device 300 may include information, but is not limited to, a type, and/or an identification number of a space in which the electronic device 300 is located. For example, the information related to the electronic device 300 may be information stored when the electronic device 300 is registered with the server 200.

According to an embodiment, the database 230 may store information related to the operation of the electronic device 300. For example, the information related to the operation of the electronic device 300 may include, but is not limited to, a location, an activation time (e.g., information related to a time when the electronic device is active, such as time, date, and season information), an operation execution time, an executed operation content (e.g., set temperature of air conditioners and/or heaters, TV channels, lighting value and/or intensity, whether electric blinds and/or gas valves are opened or closed, setting of acoustic equipment volume and/or equalizer, operating mode of robot vacuum cleaner, operating mode of washing machines, dryers and/or air dressers), an inactivation time and/or a control method (e.g., online control, offline control) of the electronic device 300 (e.g. air conditioners, electric blinds, gas valves, acoustic equipment, robot vacuum cleaners, washing machines, dryers and/or air dressers). For example, the information related to the operation of the electronic device 300 may, for example, be or include information transmitted from the electronic device 300 to the server 200 through the communication module 290 when the electronic device 300 performs the operation.

According to an embodiment, the database 230 may store information related to the associated operation of the operation of the electronic device 300. For example, information related to the associated operation of the operation of the electronic device 300 may include, but is not limited to, information on an associated device of the electronic device 300 and/or information on an associated operation of the specified operation of the electronic device 300. For example, the information related to the associated operation of the operation of the electronic device 300 may, for example, be or include information stored when the server 200 generates the associated operation based on the operation of the electronic device 300.

According to various embodiments, the communication module 290 (e.g., including communication circuitry) may receive and/or transmit various information by communicating with the electronic device 300 and/or the mobile device 1000 through a network (e.g., the first network 198 and/or the second network 199 of FIG. 1). The processor 220 (e.g., including processing circuitry) may be connected to the communication module 290 to process various information received by the communication module 290 from the electronic device 300 and/or the mobile device 1000. In addition, the processor 220 may control the communication module 290 to transmit various information to the electronic device 300 and/or the mobile device 1000.

According to various embodiments, the processor 220 may generate an associated operation based on the operation of the electronic device 300 and execute the associated operation.

According to an embodiment, the associated operation may be generated by the processor 220 and/or configured by a user.

According to an embodiment, the processor 220 may identify the operation execution of a first electronic device 310 and a second electronic device 320. For example, the processor 220 may obtain information related to the operation of the first electronic device 310 from the first electronic device 310 and information related to the operation of the second electronic device 320 from the second electronic device 320 through the communication module 290.

According to an embodiment, the processor 220 may identify whether the operation of the first electronic device 310 and the operation of the second electronic device 320 satisfy an association condition. For example, the processor 220 may identify whether the association condition is satisfied based on the information related to the operation of the first electronic device 310 and the information related to the operation of the second electronic device 320.

For example, the association condition may include whether the first electronic device 310 and the second electronic device 320 are located within a specified distance based on location information of the first electronic device 310 and location information of the second electronic device 320.

For example, the association condition may include whether a type of the first electronic device 310 and a type of the second electronic device 320 are included in a specified group based on type information of the first electronic device 310 and type information of the second electronic device 320.

For example, the association condition may include whether the first electronic device 310 and the second electronic device 320 are activated within a specified time based on an activation time of the first electronic device 310 and an activation time of the second electronic device 320.

For example, the association condition may include whether the first electronic device 310 and the second electronic device 320 are executed within a specified time based on an operation execution time of the first electronic device 310 and an operation execution time of the second electronic device 320.

For example, the association condition may include whether a number of the operation execution times of the second electronic device 320 after operation execution of the first electronic device 310 is greater than or equal to a specified number of times.

For example, the association condition may include whether a specified operation (e.g., a specified cleaning mode of a robot cleaner, a specified temperature setting of an air conditioner, and/or a specified humidity setting of a humidifier) of the second electronic device 320 has been executed after a specified operation (e.g., an operation of an air purifier in a pet mode) of the first electronic device 310 has been executed. According to an embodiment, the processor 220 may learn information related to the operation of the first electronic device 310 and information related to the operation of the second electronic device 320 through machine learning. For example, the processor 220 may determine whether the association condition is satisfied by inputting information related to the operation of the first electronic device 310 and information related to the operation of the second electronic device 320 to a learned model.

According to an embodiment, the processor 220 may generate an associated operation of the operation of the first electronic device 310. For example, the processor 220 may determine the second electronic device 320 as an associated device of the operation of the first electronic device 310 and the executed operation content of the second electronic device 320 as an associated operation content of the operation of the first electronic device 310, in response to satisfying the association condition of the operation of the first electronic device 310 and the operation of the second electronic device 320.

According to an embodiment, the processor 220 may identify the execution state of the first electronic device 310.

According to an embodiment, the processor 220 may identify whether the first electronic device 310 is located in a specified space. For example, the processor 220 may identify whether the first electronic device 310 is located in a specified space based on space information and location information of the first electronic device 310. The processor 220 may identify the space information (e.g., a living room, a room 1, a room 2, etc.) of the first electronic device 310 stored in the database 230. The processor 220 may obtain information related to the location of the first electronic device 310 from the first electronic device 310.

According to an embodiment, the processor 220 may identify whether an associated operation execution condition of the first electronic device 310 is satisfied.

For example, the processor 220 may identify information related to whether the operation of the first electronic device 310 is executed by offline control and/or whether the operation is executed by online control by identifying the control method of the first electronic device 310.

For example, the online control may be a method in which the first electronic device 310 is connected to the server 200 through a network and operates by a command obtained from the server 200. For example, the online control may be a method in which a user transmits a control command to the server 200 using the mobile device 300 and the server 200 transmits the command obtained from the mobile device 300 to the first electronic device 310.

For example, the offline control may be a method in which the first electronic device 310 operates by direct control of a user regardless of a network connection. For example, the offline control may include a method of pressing a switch and/or a button included in the first electronic device 310 or controlling by a remote control.

For example, the processor 220 may identify whether the relative distance between the first electronic device 310 and the mobile device 1000 is within a specified distance based on information related to the location of the first electronic device 310 and information related to the location of the mobile device 1000.

According to an embodiment, the processor 220 may identify the associated device of the operation of the first electronic device 310.

For example, the processor 220 may identify the associated device of the operation of the first electronic device 310 in response to the first electronic device 310 being located in a specified space and satisfying the associated operation execution condition.

For example, the processor 220 may identify information on the second electronic device 320, which is the associated device of the operation of the first electronic device 310, based on information related to the associated operation of the operation of the first electronic device 310 stored in the database 230. For example, the processor 220 may identify information on the second electronic device 320 such as space information, type, and identification number of the second electronic device 320.

According to an embodiment, the processor 220 may identify the state of the second electronic device 320.

For example, the processor 220 may identify whether the second electronic device 320 is located in the same space as the first electronic device 310. For example, the processor 220 may identify whether the second electronic device 320 is located in a specified space based on space information and location information of the second electronic device 320. The processor 220 may identify the space information (e.g., a living a room, a room 1, a room 2, etc.) of the second electronic device 320 stored in the database 230. The processor 220 may obtain information related to the location of the second electronic device 320 from the second electronic device 320.

According to an embodiment, the processor 220 may execute an associated operation on the second electronic device 320.

For example, the processor 220 may identify the operation content of the second electronic device 320, which is the associated operation content of the operation of the first electronic device 310, based on information related to the associated operation of the operation of the first electronic device 310 stored in the database 230.

For example, the processor 220 may recommend an associated operation to be executed by the second electronic device 320 to the mobile device 1000. For example, the processor 220 may transmit information related to an associated operation to be executed by the second electronic device 320 to the mobile device 1000 through the communication module 290 and obtain a response from the mobile device 1000 as to whether to execute the associated operation.

For example, the processor 220 may control the second electronic device 320 to execute an associated operation by the second electronic device 320. For example, the processor 220 may transmit a command to cause the second electronic device 320 to execute the associated operation through the communication module 290.

According to various embodiments, the electronic device 300 may be connected to the server 200 and/or the mobile device 1000 through a network to transmit information related to an operation of the electronic device 300 and receive a control command of the electronic device 300.

According to an embodiment, the electronic device 300 may transmit information related to the operation of the electronic device 300 including a location of the electronic device 300 (e.g. air conditioners, electric blinds, gas valves, acoustic equipment, robot vacuum cleaners, washing machines, dryers and/or air dressers), an activation time (e.g., information related to a time when the electronic device is active, such as time, date, and season information), an operation execution time, an executed operation content (e.g., set temperature of air conditioners and/or heaters, TV channels, lighting value and/or intensity, whether electric blinds and/or gas valves are opened or closed, setting of acoustic equipment volume and/or equalizer, operating mode of robot vacuum cleaner, operating mode of washing machines, dryers and/or air dressers), an inactivation time and/or a control method (e.g., online control, offline control) to the server 200 and/or the mobile device 1000. For example, the electronic device 300 may generate location information of the electronic device 300 using a communication module such as UWB, Wi-Fi, or BLE.

According to an embodiment, the electronic device 300 may receive a control command from the server 200 and/or the mobile device 1000. For example, the electronic device 300 may receive a control command including an operation execution time and/or operation contents by online control of the server 200 and/or the mobile device 1000 through a network. The electronic device 300 may perform an operation based on the received control command.

For example, the online control may be a method in which the first electronic device 310 is connected to the server 200 through a network and operates by a command obtained from the server 200. For example, the online control may be a method in which a user transmits a control command to the server 200 using the mobile device 300 and the server 200 transmits the command obtained from the mobile device 300 to the first electronic device 310.

For example, the offline control may be a method in which the first electronic device 310 operates by direct control of a user regardless of a network connection. For example, the offline control may include a method of pressing a switch and/or a button included in the first electronic device 310 or controlling by a remote control.

According to an embodiment, the electronic device 300 may receive a related operation execution command from the server 200. The electronic device 300 may perform an associated operation based on the received associated operation execution command.

According to various embodiments, the mobile device 1000 may be connected to the server 200 and/or the electronic device 300 through a network to register information related to the electronic device 300, receive information related to the operation of the electronic device 300, and transmit a control command of the electronic device 300.

According to an embodiment, the mobile device 1000 may register information related to the electronic device 300 with the server 200. For example, the mobile device 1000 may register the electronic device 300 with the server 200 based on information related to the electronic device 300 including information, a type, and/or an identification number of a space in which the electronic device 300 is located.

According to an embodiment, the mobile device 1000 may receive information related to the operation of the electronic device 300 including a location of the electronic device 300 (e.g. air conditioners, electric blinds, gas valves, acoustic equipment, robot vacuum cleaners, washing machines, dryers and/or air dressers), an activation time (e.g., information related to a time when the electronic device is active, such as time, date, and season information), an operation execution time, an executed operation content (e.g., set temperature of air conditioners and/or heaters, TV channels, lighting value and/or intensity, whether electric blinds and/or gas valves are opened or closed, setting of acoustic equipment volume and/or equalizer, operating mode of robot vacuum cleaner, operating mode of washing machines, dryers and/or air dressers), an inactivation time and/or a control method (e.g., online control, offline control) from the electronic device 300.

According to an embodiment, the mobile device 1000 may receive information related to an associated operation to be executed by the electronic device 300 from the server 200. For example, the mobile device 1000 may receive information related to the associated operation including information on an associated device of the electronic device 300 and/or associated operation information of a specified operation of the electronic device 300.

According to an embodiment, the mobile device 1000 may transmit a response to whether to execute the associated operation to the server 200. For example, the mobile device 1000 may transmit a response to whether the electronic device 300 executes the associated operation based on the received information related to the associated operation to the server 200.

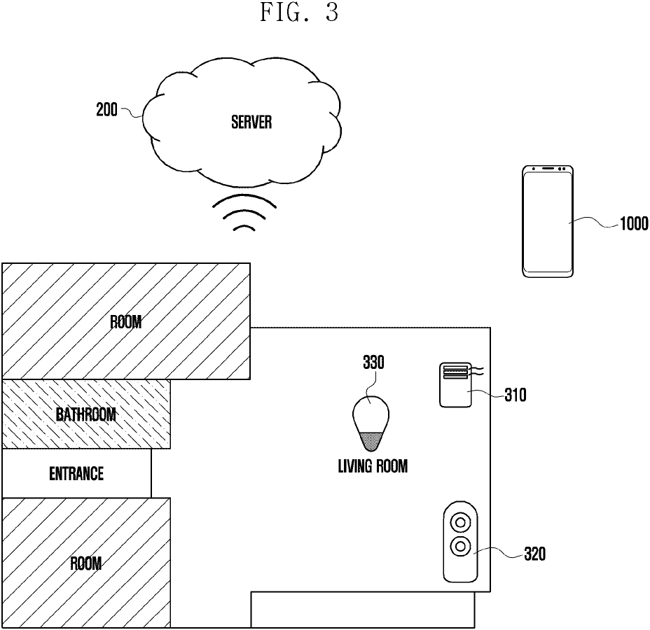

FIG. 3 is a diagram illustrating an example of an electronic device 300 control system according to various embodiments.

According to various embodiments, a first electronic device 310 (e.g., an air purifier), a second electronic device 320 (e.g., an air conditioner), and/or a third electronic device 330 (e.g., a light) may be located in a first space (e.g., a living room). The first electronic device 310, the second electronic device 320, and/or the third electronic device 330 may be the electronic device 300 of FIG. 2.

According to various embodiments, the first electronic device 310, the second electronic device 320, and/or the third electronic device 330 may be connected to the server 200 and/or the mobile device 1000 to transmit information related to an operation of the electronic device 300 and receive a control command of the electronic device 300.

According to an embodiment, the user may operate the first electronic device 310 to perform a specified operation (e.g., operation at the air purifier level 1) by online control through the mobile device 1000.

According to an embodiment, the server 200 may identify an operation of the first electronic device 310.

According to an embodiment, the first electronic device 310 may transmit information related to the operation of the first electronic device 310 to the server 200. For example, the first electronic device 310 may transmit information related to the operation executed by the first electronic device 310, such as the location of the first electronic device 310 — the first area of the living room, activation time — 11 o’clock, operation execution time — 11 o’clock, contents of the executed operation — operation at air cleaning level 1, and control method - operation in an online control method, to the server 200.

According to various embodiments, the server 200 may identify the execution state of the first electronic device 310.

According to an embodiment, the server 200 may identify whether the first electronic device 310 is located in the first space (e.g., a living room). For example, the server 200 may identify whether the first electronic device 310 is located in a specified space based on space information (e.g., a living room) and location information (e.g., first area of the living room) of the first electronic device 310.

According to an embodiment, the server 200 may identify whether the associated operation execution condition of the first electronic device 310 is satisfied.

For example, the server 200 may identify whether the relative distance between the first electronic device 310 and the mobile device 1000 is within a specified distance in response to the operation being executed by the first electronic device 310 by online control. The server 200 may identify whether a relative distance (e.g., 20 meters) between the first electronic device 310 and the mobile device 1000 is within a specified distance (e.g., 100 meters) based on information related to the location (e.g., first area of the living room) of the first electronic device 310 and the location (10 meters in front of the door) of the mobile device 1000.

According to various embodiments, the server 200 may identify an associated device of the operation of the first electronic device 310 (e.g., operation at air cleaning level 1 of the air purifier).

According to an embodiment, the server 200 may identify information on the second electronic device 320 (e.g., air conditioner) that is the associated device of the operation of the first electronic device 310 based on information related to the associated operation of the operation of the first electronic device 310 stored in the database 230. For example, the server 200 may identify information on the second electronic device 320 such as space information (e.g., a living room), type (e.g., an air conditioner), and identification number of the second electronic device 320.

According to various embodiments, the server 200 may identify the execution state of the second electronic device 320.

According to an embodiment, the server 200 may identify whether the second electronic device 320 is located in the same space (e.g., a living room) as the first electronic device 310. For example, the server 200 may identify whether the second electronic device 320 is located in a specified space based on space information (e.g., a living room) and location information (e.g., second area of the living room) of the second electronic device 320. The server 200 may identify space information (e.g., a living room) of the second electronic device 320 stored in the database 230. The server 200 may obtain information related to a location (e.g., second area of the living room) of the second electronic device 320 from the second electronic device 320.

According to various embodiments, the server 200 may execute an associated operation on the second electronic device 320.

According to an embodiment, the server 200 may identify the operation content (e.g., a cooling mode operation at 25 degrees of the air conditioner) of the second electronic device 320, which is the associated operation content of the operation (e.g., operation at air cleaning level 1 of the air purifier) of the first electronic device 310.

According to an embodiment, the server 200 may control the second electronic device 320 to execute an associated operation (e.g., a cooling mode operation at 25 degrees of the air conditioner) by the second electronic device 320. For example, the server 200 may transmit a command for the second electronic device 320 to execute the associated operation (e.g., the cooling mode operation at 25 degrees of the air conditioner) through the communication module 290.

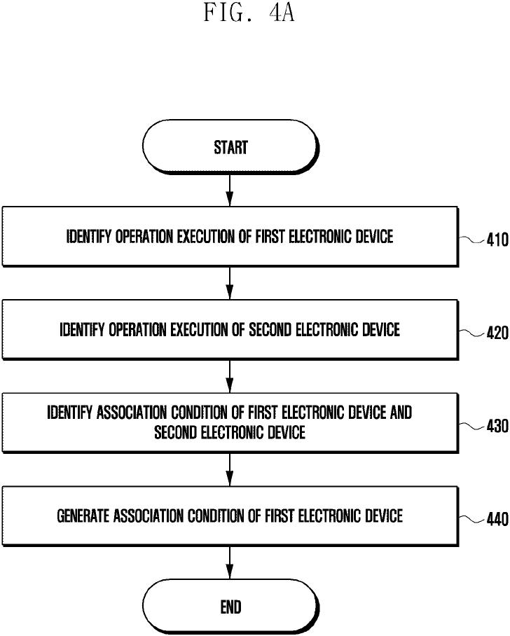

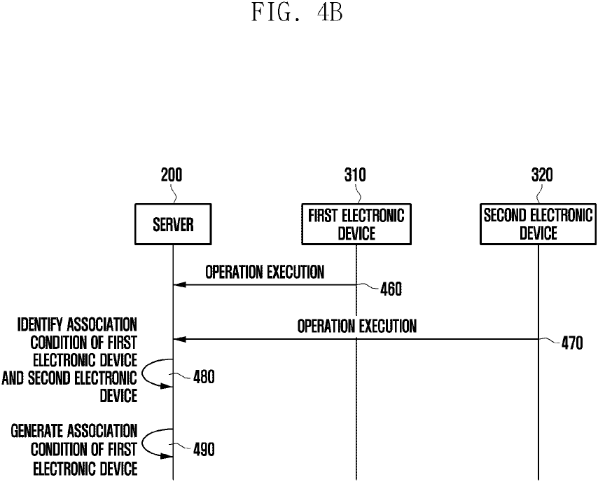

FIG. 4A is a flowchart illustrating an example method in which a server 200 generates an associated operation based on operations of electronic devices 300 according to various embodiments.

According to various embodiments, in operation 410, the processor 220 may identify an operation execution of the first electronic device 310.

According to an embodiment, the processor 220 may obtain information related to the operation of the first electronic device 310 from the first electronic device 310 through the communication module 290. For example, the first electronic device 310 (e.g. air conditioners, electric blinds, gas valves, acoustic equipment, robot vacuum cleaners, washing machines, dryers and/or air dressers) may deliver information related to the operation executed by the first electronic device 310 such as a location of the first electronic device 310, an activation time (e.g., information related to the time when the electronic device is active, such as time, date, and season information), an operation execution time, an executed operation content (e.g., set temperature of air conditioners and/or heaters, TV channels, lighting value and/or intensity, whether electric blinds and/or gas valves are opened or closed, setting of acoustic equipment volume and/or equalizer, operating mode of robot vacuum cleaner, operating mode of washing machines, dryers and/or air dressers), an inactivation time and/or a control method (e.g., online control, offline control) to the server 200.

According to an embodiment, the processor 220 may store information related to the operation of the first electronic device 310 in the database 230.

According to various embodiments, in operation 420, the processor 220 may identify an operation execution of the second electronic device 320.

According to an embodiment, the processor 220 may obtain information related to the operation of the second electronic device 320 (e.g. air conditioners, electric blinds, gas valves, acoustic equipment, robot vacuum cleaners, washing machines, dryers and/or air dressers) from the second electronic device 320 through the communication module 290. For example, the second electronic device 320 may deliver information related to the operation executed by the second electronic device 320 such as a location of the second electronic device 320, an activation time (e.g., information related to the time when the electronic device is active, such as time, date, and season information), an operation execution time, an executed operation content (e.g., set temperature of air conditioners and/or heaters, TV channels, lighting value and/or intensity, whether electric blinds and/or gas valves are opened or closed, setting of acoustic equipment volume and/or equalizer, operating mode of robot vacuum cleaner, operating mode of washing machines, dryers and/or air dressers), an inactivation time and/or a control method (e.g., online control, offline control) to the server 200.

According to an embodiment, the processor 220 may store information related to the operation of the second electronic device 320 in the database 230.

According to various embodiments, in operation 430, the processor 220 may identify whether the operation of the first electronic device 310 and the operation of the second electronic device 320 satisfy an association condition.

According to an embodiment, the association condition may be generated by the processor 220 and/or configured by a user.

According to an embodiment, the processor 220 may identify whether the association condition is satisfied based on the information related to the operation of the first electronic device 310 and the information related to the operation of the second electronic device 320.

For example, the association condition may include whether the first electronic device 310 and the second electronic device 320 are located within a specified distance based on the location information of the first electronic device 310 and the location information of the second electronic device 320.

For example, the association condition may include whether a type of the first electronic device 310 and a type of the second electronic device 320 are included in a specified group based on type information of the first electronic device 310 and type information of the second electronic device 320.

For example, the association condition may include whether the first electronic device 310 and the second electronic device 320 are activated within a specified time based on an activation time of the first electronic device 310 and an activation time of the second electronic device 320.

For example, the association condition may include whether the first electronic device 310 and the second electronic device 320 are executed within a specified time based on an operation execution time of the first electronic device 310 and an operation execution time of the second electronic device 320.

For example, the association condition may include whether a number of operation execution times of the second electronic device 320 after operation execution of the first electronic device 310 is greater than or equal to a specified number of times.

For example, the association condition may include whether a specified operation (e.g., a specified cleaning mode of a robot cleaner, a specified temperature setting of an air conditioner, and/or a specified humidity setting of a humidifier) of the second electronic device 320 has been executed after a specified operation (e.g., an operation of an air purifier in a pet mode) of the first electronic device 310 has been executed.

According to an embodiment, the processor 220 may learn information related to the operation of the first electronic device 310 and information related to the operation of the second electronic device 320 through machine learning. For example, the processor 220 may determine whether the association condition is satisfied by inputting information related to the operation of the first electronic device 310 and information related to the operation of the second electronic device 320 to the learned model.

According to various embodiments, in operation 440, the processor 220 may generate an associated operation of the operation of the first electronic device 310.

According to an embodiment, the processor 220 may determine the second electronic device 320 as the associated device of the operation of the first electronic device 310, and the executed operation content of the second electronic device 320 as the associated operation content of the operation of the first electronic device 310 in response to satisfying the association conditions between operation of the first electronic device 310 and operation of the second electronic device 320.

According to an embodiment, the processor 220 may store information related to the associated operation of the operation of the first electronic device 310 in the database 230. For example, the information related to the associated operation of the operation of the first electronic device 310 may include information (e.g., space information, type and/or identification number of the second electronic device) related to the second electronic device 320, which is information on the associated device of the operation of the first electronic device 310, and the executed operation content (e.g., set temperature of air conditioners and/or heaters, TV channels, lighting value and/or intensity, whether electric blinds and/or gas valves are opened or closed, setting of acoustic equipment volume and/or equalizer, operating mode of robot vacuum cleaner, operating mode of washing machines, dryers and/or air dressers), which is the associated operation content of the operation of the first electronic device 310.

FIG. 4B is a flowchart illustrating an example method in which a server 200 generates an associated operation based on operations of electronic devices 300 in a system according to various embodiments.

According to various embodiments, in operation 460, the first electronic device 310 may notify the server 200 of operation execution.

According to an embodiment, the first electronic device 310 may transmit information related to an operation of the first electronic device 310 to the server 200. For example, the first electronic device 310 may deliver information related to the operation executed by the first electronic device 310 such as a location of the first electronic device 310, an activation time (e.g., information related to the time when the electronic device is active, such as time, date, and season information), an operation execution time, an executed operation content (e.g., set temperature of air conditioners and/or heaters, TV channels, lighting value and/or intensity, whether electric blinds and/or gas valves are opened or closed, setting of acoustic equipment volume and/or equalizer, operating mode of robot vacuum cleaner, operating mode of washing machines, dryers and/or air dressers), an inactivation time and/or a control method (e.g., online control, offline control) to the server 200.

According to an embodiment, the server 200 may store information related to the operation of the first electronic device 310 in the database 230.

According to various embodiments, in operation 470, the second electronic device 320 may notify the server 200 of the operation execution of the second electronic device 320.

According to an embodiment, the second electronic device 320 may transmit information related to the operation of the second electronic device 320 from the second electronic device 320 to the server 200. For example, the second electronic device 320 may deliver information related to the operation executed by the second electronic device 320 such as a location of the second electronic device 320, an activation time (e.g., information related to the time when the electronic device is active, such as time, date, and season information), an operation execution time, an executed operation content (e.g., set temperature of air conditioners and/or heaters, TV channels, lighting value and/or intensity, whether electric blinds and/or gas valves are opened or closed, setting of acoustic equipment volume and/or equalizer, operating mode of robot vacuum cleaner, operating mode of washing machines, dryers and/or air dressers), an inactivation time and/or a control method (e.g., online control, offline control) to the server 200.

According to an embodiment, the server 200 may store information related to the operation of the second electronic device 320 in the database 230.

According to various embodiments, in operation 480, the server 200 may identify whether the operation of the first electronic device 310 and the operation of the second electronic device 320 satisfy an association condition.

According to an embodiment, the server 200 may identify whether the association condition is satisfied based on the information related to the operation of the first electronic device 310 and the information related to the operation of the second electronic device 320.

For example, the association condition may include whether the first electronic device 310 and the second electronic device 320 are located within a specified distance based on the location information of the first electronic device 310 and the location information of the second electronic device 320.

For example, the association condition may include whether a type of the first electronic device 310 and a type of the second electronic device 320 are included in a specified group based on type information of the first electronic device 310 and type information of the second electronic device 320.

For example, the association condition may include whether the first electronic device 310 and the second electronic device 320 are activated within a specified time based on an activation time of the first electronic device 310 and an activation time of the second electronic device 320.

For example, the association condition may include whether the first electronic device 310 and the second electronic device 320 are executed within a specified time based on an operation execution time of the first electronic device 310 and an operation execution time of the second electronic device 320.

For example, the association condition may include whether a number of the operation execution times of the second electronic device 320 after the operation execution of the first electronic device 310 is greater than or equal to a specified number of times.

For example, the association condition may include whether a specified operation (e.g., a specified cleaning mode of a robot cleaner, a specified temperature setting of an air conditioner, and/or a specified humidity setting of a humidifier) of the second electronic device 320 has been executed after the specified operation (e.g., an operation of an air purifier in a pet mode) of the first electronic device 310 has been executed.

According to an embodiment, the server 200 may learn information related to the operation of the first electronic device 310 and information related to the operation of the second electronic device 320 through machine learning. For example, the server 200 may determine whether the association condition is satisfied by inputting information related to the operation of the first electronic device 310 and information related to the operation of the second electronic device 320 to the learned model.

According to various embodiments, in operation 490, the server 200 may generate an associated operation of the operation of the first electronic device 310.

According to an embodiment, the server 200 may determine the second electronic device 320 as the associated device of the operation of the first electronic device 310, and the executed operation content of the second electronic device 320 as the associated operation content of the operation of the first electronic device 310 in response to satisfying the association conditions between the operation of the first electronic device 310 and the operation of the second electronic device 320.

According to an embodiment, the server 200 may store information related to the associated operation of the operation of the first electronic device 310 in the database 230. For example, the information related to the associated operation of the operation of the first electronic device 310 may include information (e.g., space information, type and/or identification number of the second electronic device) related to the second electronic device 320, which is information on the associated device of the operation of the first electronic device 310, and the executed operation content (e.g., set temperature of air conditioners and/or heaters, TV channels, lighting value and/or intensity, whether electric blinds and/or gas valves are opened or closed, setting of acoustic equipment volume and/or equalizer, operating mode of robot vacuum cleaner, operating mode of washing machines, dryers and/or air dressers), which is the associated operation content of the operation of the first electronic device 310.

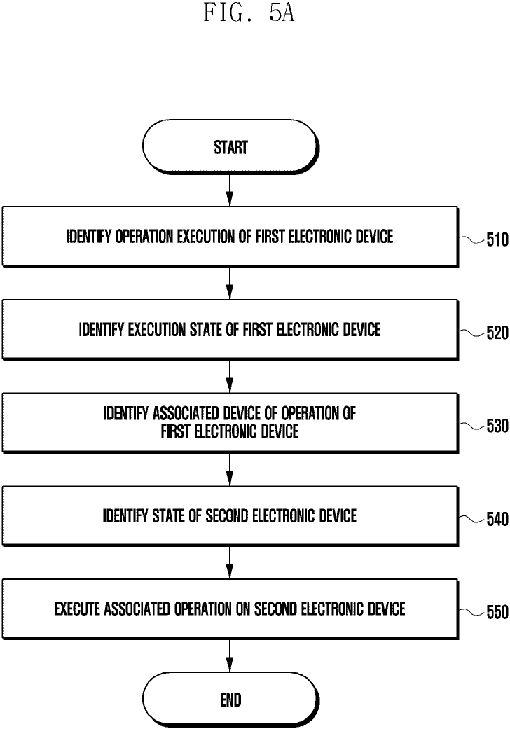

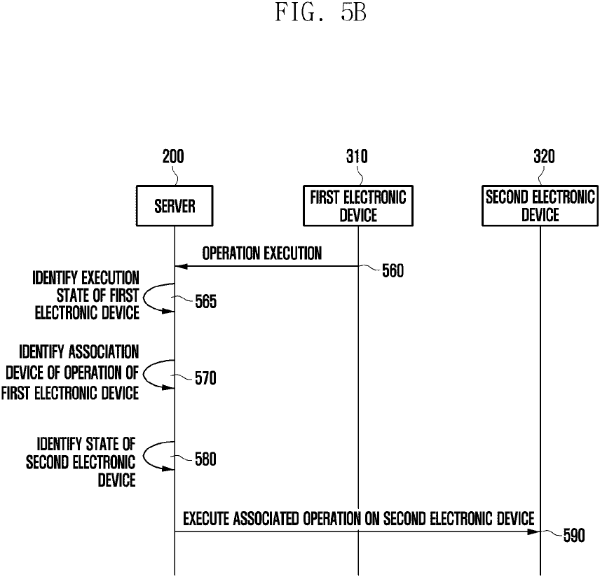

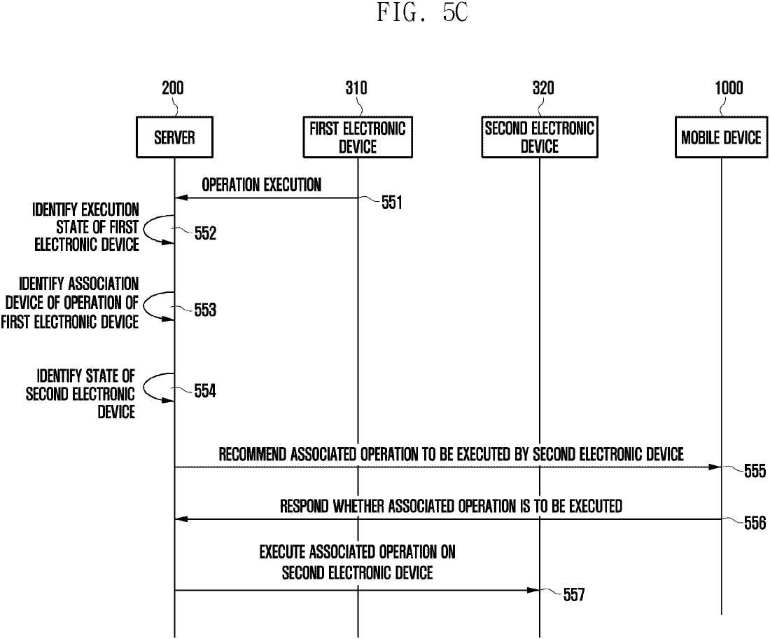

FIG. 5A is a flowchart illustrating an example method in which a server 200 executes an associated operation based on operations of electronic devices 300 according to various embodiments.

According to various embodiments, in operation 510, the processor 220 may identify an operation execution of the first electronic device 310.

According to an embodiment, the processor 220 may obtain information related to the operation of the first electronic device 310 (e.g. air conditioners, electric blinds, gas valves, acoustic equipment, robot vacuum cleaners, washing machines, dryers and/or air dressers) from the first electronic device 310 through the communication module 290. For example, the first electronic device 310 may deliver information related to the operation executed by the first electronic device 310 such as a location of the first electronic device 310, an activation time (e.g., information related to the time when the electronic device is active, such as time, date, and season information), an operation execution time, an executed operation content (e.g., set temperature of air conditioners and/or heaters, TV channels, lighting value and/or intensity, whether electric blinds and/or gas valves are opened or closed, setting of acoustic equipment volume and/or equalizer, operating mode of robot vacuum cleaner, operating mode of washing machines, dryers and/or air dressers), an inactivation time and/or a control method (e.g., online control, offline control) to the server 200.

According to various embodiments, in operation 520, the processor 220 may identify the execution state of first electronic device 310.

According to an embodiment, the processor 220 may identify whether the first electronic device 310 is located in a specified space. For example, the processor 220 may identify whether the first electronic device 310 is located in a specified space based on space information and location information of the first electronic device 310. The processor 220 may identify the space information (e.g., a living room, a room 1, a room 2, etc.) of the first electronic device 310 stored in the database 230. The processor 220 may obtain information related to the location of the first electronic device 310 from the first electronic device 310.

According to an embodiment, the processor 220 may identify whether an associated operation execution condition of the first electronic device 310 is satisfied. For example, the associated operation execution condition may include whether the operation of the first electronic device 310 is executed by offline control. The processor 220 may identify information related to whether the operation of the first electronic device 310 is executed by offline control and/or whether the operation is executed by online control by identifying the control method of the first electronic device 310.

For example, the associated operation execution condition may include whether the relative distance between the first electronic device 310 and the mobile device 1000 is within a specified distance in response to the operation being executed by the first electronic device 310 by online control. The processor 220 may identify whether a relative distance between the first electronic device 310 and the mobile device 1000 is within a specified distance based on information related to the location of the first electronic device 310 and the location of the mobile device 1000.

According to various embodiments, in operation 530, the processor 220 may identify an associated device of the operation of the first electronic device 310.

According to an embodiment, the processor 220 may identify the associated device of the operation of the first electronic device 310 in response to the first electronic device 310 being located in a specified space and satisfying the associated operation execution condition.

According to an embodiment, the processor 220 may identify information on the second electronic device 320 that is the associated device of the operation of the first electronic device 310 based on information related to the associated operation of the operation of the first electronic device 310 stored in the database 230. For example, the processor 220 may identify information on the second electronic device 320 such as space information, type, and identification number of the second electronic device 320.

According to various embodiments, in operation 540, the processor 220 may identify the execution state of the second electronic device 320.

According to an embodiment, the processor 220 may identify whether the second electronic device 320 is located in the same space as the first electronic device 310. For example, the processor 220 may identify whether the second electronic device 320 is located in a specified space based on space information and location information of the second electronic device 320. The processor 220 may identify space information (e.g., a living room, a room 1, a room 2, etc.) of the second electronic device 320 stored in the database 230. The processor 220 may obtain information related to a location of the second electronic device 320 from the second electronic device 320.

According to various embodiments, in operation 550, the processor 220 may execute an associated operation on the second electronic device 320.

According to an embodiment, the processor 220 may identify the operation content of the second electronic device 320, which is the associated operation content of the operation of the first electronic device 310 based on the information related to the associated operation of the operation of the first electronic device 310 stored in the database 230.

According to an embodiment, the processor 220 may recommend an associated operation to be executed by the second electronic device 320 to the mobile device 1000. For example, the processor 220 may transmit information related to an associated operation to be executed by the second electronic device 320 to the mobile device 1000 through the communication module 290 and obtain a response from the mobile device 1000 as to whether to execute the associated operation.

According to an embodiment, the processor 220 may control the second electronic device 320 to execute an associated operation by the second electronic device 320. For example, the processor 220 may transmit a command to cause the second electronic device 320 to execute the associated operation through the communication module 290.

FIG. 5B is a flowchart illustrating an example method in which a server 200 executes an associated operation based on operations of electronic devices 300 in a system according to various embodiments.

According to various embodiments, in operation 560, the first electronic device 310 may notify the server 200 of operation execution.

According to an embodiment, the first electronic device 310 may transmit information related to an operation of the first electronic device 310 to the server 200. For example, the first electronic device 310 may transmit information related to the operation executed by the first electronic device 310 such as a location of the first electronic device 310, an activation time (e.g., information related to the time when the electronic device is active, such as time, date, and season information), an operation execution time, an executed operation content (e.g., set temperature of air conditioners and/or heaters, TV channels, lighting value and/or intensity, whether electric blinds and/or gas valves are opened or closed, setting of acoustic equipment volume and/or equalizer, operating mode of robot vacuum cleaner, operating mode of washing machines, dryers and/or air dressers), an inactivation time and/or a control method (e.g., online control, offline control) to the server 200.

According to various embodiments, in operation 565, the server 200 may identify the execution state of first electronic device 310.

According to an embodiment, the server 200 may identify whether the first electronic device 310 is located in a specified space. For example, the server 200 may identify whether the first electronic device 310 is located in a specified space based on space information and location information of the first electronic device 310. The server 200 may identify the space information (e.g., a living room, a room 1, a room 2, etc.) of the first electronic device 310 stored in the database 230. The server 200 may obtain information related to the location of the first electronic device 310 from the first electronic device 310.

According to an embodiment, the server 200 may identify whether an associated operation execution condition of the first electronic device 310 is satisfied.

For example, the associated operation execution condition may include whether the operation of the first electronic device 310 is executed by offline control. The server 200 may identify information related to whether the operation of the first electronic device 310 is executed by offline control and/or whether the operation is executed by online control by identifying the control method of the first electronic device 310.

For example, the associated operation execution condition may include whether the relative distance between the first electronic device 310 and the mobile device 1000 is within a specified distance in response to the operation being executed by the first electronic device 310 by online control. The server 200 may identify whether a relative distance between the first electronic device 310 and the mobile device 1000 is within a specified distance based on information related to the location of the first electronic device 310 and the location of the mobile device 1000.

According to various embodiments, in operation 570, the server 200 may identify an associated device of the operation of the first electronic device 310.

According to an embodiment, the server 200 may identify the associated device of the operation of the first electronic device 310 in response to the first electronic device 310 being located in a specified space and satisfying the associated operation execution condition.

According to an embodiment, the server 200 may identify information on the second electronic device 320 that is the associated device of the operation of the first electronic device 310 based on information related to the associated operation of the operation of the first electronic device 310 stored in the database 230. For example, the server 200 may identify information on the second electronic device 320 such as space information, type, and identification number of the second electronic device 320.

According to various embodiments, in operation 580, the server 200 may identify the execution state of the second electronic device 320.

According to an embodiment, the server 200 may identify whether the second electronic device 320 is located in the same space as the first electronic device 310. For example, the server 200 may identify whether the second electronic device 320 is located in a specified space based on space information and location information of the second electronic device 320. The server 200 may identify space information (e.g., a living room, a room 1, a room 2, etc.) of the second electronic device 320 stored in the database 230. The server 200 may obtain information related to a location of the second electronic device 320 from the second electronic device 320.

According to various embodiments, in operation 590, the server 200 may execute an associated operation on the second electronic device 320.

According to an embodiment, the server 200 may identify the operation content of the second electronic device 320, which is the associated operation content of the operation of the first electronic device 310 based on the information related to the associated operation of the operation of the first electronic device 310 stored in the database 230 in response to the second electronic device 320 being located in the same space as the first electronic device 310.

According to an embodiment, the server 200 may control the second electronic device 320 to execute an associated operation by the second electronic device 320. For example, the server 200 may transmit a command to cause the second electronic device 320 to execute the associated operation through the communication module 290.

FIG. 5C is a flowchart illustrating a method in which a server 200 executes an associated operation based on operations of electronic devices 300 in a system according to various embodiments.

According to various embodiments, in operation 551, the first electronic device 310 may notify the server 200 of operation execution.

According to an embodiment, the first electronic device 310 may transmit information related to an operation of the first electronic device 310 to the server 200. For example, the first electronic device 310 may transmit information related to the operation executed by the first electronic device 310 such as a location of the first electronic device 310, an activation time (e.g., information related to the time when the electronic device is active, such as time, date, and season information), an operation execution time, an executed operation content (e.g., set temperature of air conditioners and/or heaters, TV channels, lighting value and/or intensity, whether electric blinds and/or gas valves are opened or closed, setting of acoustic equipment volume and/or equalizer, operating mode of robot vacuum cleaner, operating mode of washing machines, dryers and/or air dressers), an inactivation time and/or a control method (e.g., online control, offline control) to the server 200.

According to various embodiments, in operation 552, the server 200 may identify the execution state of first electronic device 310.

According to an embodiment, the server 200 may identify whether the first electronic device 310 is located in a specified space. For example, the server 200 may identify whether the first electronic device 310 is located in a specified space based on space information and location information of the first electronic device 310. The server 200 may identify the space information (e.g., a living room, a room 1, a room 2, etc.) of the first electronic device 310 stored in the database 230. The server 200 may obtain information related to the location of the first electronic device 310 from the first electronic device 310.

According to an embodiment, the server 200 may identify whether an associated operation execution condition of the first electronic device 310 is satisfied.

For example, the associated operation execution condition may include whether the operation of the first electronic device 310 is executed by offline control. The server 200 may identify information related to whether the operation of the first electronic device 310 is executed by offline control and/or whether the operation is executed by online control by identifying the control method of the first electronic device 310.

For example, the associated operation execution condition may include whether the relative distance between the first electronic device 310 and the mobile device 1000 is within a specified distance in response to the operation being executed by the first electronic device 310 by online control. The server 200 may identify whether a relative distance between the first electronic device 310 and the mobile device 1000 is within a specified distance based on information related to the location of the first electronic device 310 and the location of the mobile device 1000.

According to various embodiments, in operation 553, the server 200 may identify an associated device of the operation of the first electronic device 310.

According to an embodiment, the server 200 may identify the associated device of the operation of the first electronic device 310 in response to the first electronic device 310 being located in a specified space and satisfying the associated operation execution condition.

According to an embodiment, the server 200 may identify information on the second electronic device 320 that is the associated device of the operation of the first electronic device 310 based on information related to the associated operation of the operation of the first electronic device 310 stored in the database 230. For example, the server 200 may identify information on the second electronic device 320 such as space information, type, and identification number of the second electronic device 320.

According to various embodiments, in operation 554, the server 200 may identify the execution state of the second electronic device 320.

According to an embodiment, the server 200 may identify whether the second electronic device 320 is located in the same space as the first electronic device 310. For example, the server 200 may identify whether the second electronic device 320 is located in a specified space based on space information and location information of the second electronic device 320. The server 200 may identify space information (e.g., a living room, a room 1, a room 2) of the second electronic device 320 stored in the database 230. The server 200 may obtain information related to a location of the second electronic device 320 from the second electronic device 320.

According to an embodiment, the server 200 may identify the operation content of the second electronic device 320, which is the associated operation content of the operation of the first electronic device 310 based on the information related to the associated operation of the operation of the first electronic device 310 stored in the database 230 in response to the second electronic device 320 being located in the same space as the first electronic device 310.

According to various embodiments, in operation 555, the server 200 may recommend an associated operation to be executed by the second electronic device 320 to the mobile device 1000.

According to an embodiment, the server 200 may deliver information related to the associated operation to be executed by the second electronic device 320 to the mobile device 1000 through the communication module 290.

According to various embodiments, in operation 556, the mobile device 1000 may deliver a response to whether the associated operation is to be executed to the server 200.

According to an embodiment, the mobile device 1000 may transmit a response to whether to execute the associated operation to the server 200. For example, the mobile device 1000 may transmit a response to whether the electronic device 300 executes the associated operation based on the received information related to the associated operation to the server 200.

According to various embodiments, in operation 557, the server 200 may execute an associated operation on the second electronic device 320.

According to an embodiment, the server 200 may control the second electronic device 320 to execute the associated operation by the second electronic device 320 in response to the associated operation execution response of the mobile device 1000. For example, the server 200 may transmit a command to cause the second electronic device 320 to execute the associated operation through the communication module 290.

An electronic device according to various embodiments may include a communication module communicating with at least one of a first external electronic device and a second external electronic device, wherein the first external electronic device may perform a first operation, a database storing information related to at least one associated device and at least one associated operation for controlling the at least one associated device with a specified command in response to a specified operation of the first external electronic device, wherein the at least one associated device may include the second external electronic device and wherein the at least one associated operation may include a second operation, and a processor, wherein the processor may identify that a first operation of the first external electronic device is executed, identify, from the database, a second external electronic device that is an associated device corresponding to the first operation of the first external electronic device and a second operation that is an associated operation, in response to identifying that the first external electronic device is located in a specified space and satisfies an associated operation execution condition, and transmit a command for executing the second operation to the second external electronic device through the communication module.

In the electronic device according to various embodiments, the database may store space information of the first external electronic device, the processor may obtain location information of the first external electronic device through the communication module, and identify that the first external electronic device is located in the specified space based on the space information of the first external electronic device and the location information of the first external electronic device.

In the electronic device according to various embodiments, the processor may obtain information related to a control method of the first external electronic device through the communication module, and identify that the associated operation execution condition is satisfied in response to the control method of the first external electronic device being an offline control method in which the first external electronic device is directly controlled by a user regardless of network connection.

In the electronic device according to various embodiments, the processor may identify that the associated operation execution condition is satisfied in response to the control method of the first external electronic device being an online control method in which the first external electronic device is controlled using a mobile device, and in response to the location of the first external electronic device and the location of the mobile device being less than or equal to a specified distance.

In the electronic device according to various embodiments, the database may store space information of the second external electronic device, and the processor may obtain location information of the second external electronic device through the communication module, identify that the second external electronic device is located in a specified space based on the space information of the second external electronic device and the location information of the second external electronic device, and transmit a command for executing the second operation to the second external electronic device in response to the second external electronic device being located in the specified space.

In the electronic device according to various embodiments, the processor may transmit information related to the second operation to be executed by the second external electronic device to a mobile device through the communication module, and transmit a command to execute the second operation to the second external electronic device in response to receiving from the mobile device a response to the transmitted second operation information.

In the electronic device according to various embodiments, the processor may generate the at least one associated device and the at least one associated operation of the first operation of the first external electronic device before identifying that the first operation of the first external electronic device is executed, and store information related to the at least one associated device and the at least one associated operation in the database.

In the electronic device according to various embodiments, it is identified that the first operation of the first external electronic device is executed and the second operation of the second external electronic device is executed, and the second operation of the second external electronic device may be stored as an associated operation of the first operation of the first external electronic device in response to the first operation of the first external electronic device and the second operation of the second external electronic device satisfying an association condition.

In the electronic device according to various embodiments, the associated condition may be based on at least one of location information, type information, activation time, or operation execution time of the first external electronic device and the second external electronic device.

In the electronic device according to various embodiments, the processor may generate the association condition by learning at least one of location information, type information, activation time, or operation execution time of the first external electronic device and the second external electronic device.

An operation method of an electronic device according to various embodiments may include identifying that a first operation of a first external electronic device is executed, identifying information stored in a database in response to identifying that the first external electronic device is located in a specified space and satisfies an associated operation execution condition, wherein the database may store information related to at least one associated device and at least one associated operation for controlling the at least one associated device with a specified command in response to a specified operation of the first external electronic device, wherein the at least one associated device includes the second external electronic device and wherein the at least one associated operation includes a second operation, identifying, from the database, a second external electronic device that is an associated device corresponding to a first operation of the first external electronic device and a second operation that is an associated operation, and transmitting a command for executing the second operation to the second external electronic device through a communication module.

The operation method of the electronic device according to various embodiments may include storing space information of the first external electronic device, obtaining location information of the first external electronic device, and identifying that the first external electronic device is located in the specified space based on the space information of the first external electronic device and the location information of the first external electronic device.

The operation method of the electronic device according to various embodiments may include obtaining information related to a control method of the first external electronic device, and identifying that the associated operation execution condition is satisfied in response to the control method of the first external electronic device being an offline control method in which the first external electronic device is directly controlled by a user regardless of network connection.

The operation method of the electronic device according to various embodiments may include identifying that the associated operation execution condition is satisfied in response to the control method of the first external electronic device being an online control method in which the first external electronic device is controlled using a mobile device, and in response to the location of the first external electronic device and the location of the mobile device being less than or equal to a specified distance.

The operation method of the electronic device according to various embodiments may include storing space information of the second external electronic device, obtaining location information of the second external electronic device, identifying that the second external electronic device is located in a specified space based on the space information of the second external electronic device and the location information of the second external electronic device, and transmitting a command for executing the second operation to the second external electronic device in response to the second external electronic device being located in the specified space.

The operation method of the electronic device according to various embodiments may include transmitting information related to the second operation to be executed by the second external electronic device to a mobile device, and transmitting a command to execute the second operation to the second external electronic device in response to receiving from the mobile device a response to the transmitted second operation information.

The operation method of the electronic device according to various embodiments may include generating the at least one associated device and the at least one associated operation of the first operation of the first external electronic device before identifying that the first operation of the first external electronic device is executed, and storing information related to the at least one associated device and the at least one associated operation.

The operation method of the electronic device according to various embodiments may further include identifying that the first operation of the first external electronic device is executed, identifying that the second operation of the second external electronic device is executed, and storing the second operation of the second external electronic device as an associated operation of the first operation of the first external electronic device in response to the first operation of the first external electronic device and the second operation of the second external electronic device satisfying an association condition.

In the operation method of the electronic device according to various embodiments, the associated condition may be based on at least one of location information, type information, activation time, or operation execution time of the first external electronic device and the second external electronic device.

The operation method of the electronic device according to various embodiments may include generating the association condition by learning at least one of location information, type information, activation time, or operation execution time of the first external electronic device and the second external electronic device.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. The term “non-transitory” storage medium may, for example, refer to a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer’s server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. An electronic device comprising:
a communication module, including communication circuitry, configured to communicate with at least one of a first external electronic device and a second external electronic device, wherein the first external electronic device is able to perform a first operation;
a database configured to store information related to at least one associated device and at least one associated operation for controlling the at least one associated device with a specified command in response to a specified operation of the first external electronic device, wherein the at least one associated device includes the second external electronic device and wherein the at least one associated operation includes a second operation; and
at least one processor,
wherein the at least one processor is configured to:
identify that a first operation of the first external electronic device is executed;
identify, from the database, a second external electronic device that is an associated device corresponding to the first operation of the first external electronic device and a second operation that is an associated operation, in response to identifying that the first external electronic device is located in a specified space and satisfies an associated operation execution condition; and
transmit a command for executing the second operation to the second external electronic device through the communication module.

2. The electronic device of claim 1, wherein the database is configured to store space information of the first external electronic device, and
wherein the at least one processor is configured to:
obtain location information of the first external electronic device through the communication module; and
identify that the first external electronic device is located in the specified space based on the space information of the first external electronic device and the location information of the first external electronic device.

3. The electronic device of claim 1, wherein the at least one processor is configured to:
obtain information related to a control method of the first external electronic device through the communication module; and
identify that the associated operation execution condition is satisfied in response to the control method of the first external electronic device being an offline control method in which the first external electronic device is directly controlled by a user regardless of network connection.

4. The electronic device of claim 3, wherein the at least one processor is configured to:
identify that the associated operation execution condition is satisfied in response to the control method of the first external electronic device being an online control method in which the first external electronic device is controlled using a mobile device, and in response to the location of the first external electronic device and the location of the mobile device being less than or equal to a specified distance.

5. The electronic device of claim 1, wherein the database is configured to store space information of the second external electronic device, and
wherein the at least one processor is configured to:
obtain location information of the second external electronic device through the communication module;
identify that the second external electronic device is located in a specified space based on the space information of the second external electronic device and the location information of the second external electronic device; and
transmit a command for executing the second operation to the second external electronic device in response to the second external electronic device being located in the specified space.

6. The electronic device of claim 1, wherein the at least one processor is configured to:
transmit information related to the second operation to be executed by the second external electronic device to a mobile device through the communication module; and
transmit a command to execute the second operation to the second external electronic device in response to receiving from the mobile device a response to the transmitted second operation information.

7. The electronic device of claim 1, wherein the at least one processor is configured to:
generate the at least one associated device and the at least one associated operation of the first operation of the first external electronic device before identifying that the first operation of the first external electronic device is executed; and
store information related to the at least one associated device and the at least one associated operation in the database.

8. The electronic device of claim 7, further comprising:
identifying that the first operation of the first external electronic device is executed;
identifying that the second operation of the second external electronic device is executed; and
storing the second operation of the second external electronic device as an associated operation of the first operation of the first external electronic device in response to the first operation of the first external electronic device and the second operation of the second external electronic device satisfying an association condition.

9. The electronic device of claim 8, wherein the associated condition is based on at least one of location information, type information, activation time, or operation execution time of the first external electronic device and the second external electronic device.

10. The electronic device of claim 9, wherein the at least one processor is configured to:
generate the association condition by learning at least one of location information, type information, activation time, or operation execution time of the first external electronic device and the second external electronic device.

11. A method for operating an electronic device, the method comprising:
identifying that a first operation of a first external electronic device is executed;
identifying information stored in a database in response to identifying that the first external electronic device is located in a specified space and satisfies an associated operation execution condition, wherein the database stores information related to at least one associated device and at least one associated operation for controlling the at least one associated device with a specified command in response to a specified operation of the first external electronic device, wherein the at least one associated device includes the second external electronic device and wherein the at least one associated operation includes a second operation;
identifying, from the database, a second external electronic device that is an associated device corresponding to a first operation of the first external electronic device and a second operation that is an associated operation; and
transmitting a command for executing the second operation to the second external electronic device through a communication module.

12. The method of claim 11, further comprising:
storing space information of the first external electronic device;
obtaining location information of the first external electronic device; and
identifying that the first external electronic device is located in the specified space based on the space information of the first external electronic device and the location information of the first external electronic device.

13. The method of claim 11, further comprising:
obtaining information related to a control method of the first external electronic device; and
identifying that the associated operation execution condition is satisfied in response to the control method of the first external electronic device being an offline control method in which the first external electronic device is directly controlled by a user regardless of network connection.

14. The method of claim 13, further comprising:
identifying that the associated operation execution condition is satisfied in response to the control method of the first external electronic device being an online control method in which the first external electronic device is controlled using a mobile device, and in response to the location of the first external electronic device and the location of the mobile device being less than or equal to a specified distance.

15. The method of claim 11, further comprising:
storing space information of the second external electronic device;
obtaining location information of the second external electronic device;
identifying that the second external electronic device is located in a specified space based on the space information of the second external electronic device and the location information of the second external electronic device; and
transmitting a command for executing the second operation to the second external electronic device in response to the second external electronic device being located in the specified space.

16. The method of claim 11, further comprising:
transmitting information related to the second operation to be executed by the second external electronic device to a mobile device; and
transmitting a command to execute the second operation to the second external electronic device in response to receiving from the mobile device a response to the transmitted second operation information.

17. The method of claim 11, further comprising:
generating the at least one associated device and the at least one associated operation of the first operation of the first external electronic device before identifying that the first operation of the first external electronic device is executed; and
storing information related to the at least one associated device and the at least one associated operation.

18. The method of claim 17, further comprising:
identifying that the first operation of the first external electronic device is executed;
identifying that the second operation of the second external electronic device is executed; and
storing the second operation of the second external electronic device as an associated operation of the first operation of the first external electronic device in response to the first operation of the first external electronic device and the second operation of the second external electronic device satisfying an association condition.

19. The method of claim 18, wherein the associated condition is based on at least one of location information, type information, activation time, or operation execution time of the first external electronic device and the second external electronic device.

20. The method of claim 19, further comprising
generating the association condition by learning at least one of location information, type information, activation time, or operation execution time of the first external electronic device and the second external electronic device.
